(19) United States
(12) Patent Application Publication
(10) Pub. No.: US 2004/0166859 A1
(43) Pub. Date: Aug. 26, 2004

(54) Communication system, communication method, and mobile node and gateway for use with the system

(76) Inventors: Koki Hayashi, Tokyo (JP); Toshikazu Maruyama, Tokyo (JP); Satoko Fukushi, Tokyo (JP); Toshiaki Yagami, Tokyo (JP); Tomoya Arai, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/776,285

(22) Filed: Feb. 12, 2004

(30) Foreign Application Priority Data
Feb. 24, 2003 (JP) 045323/2003

(51) Int. Cl. H04Q 7/20

(52) U.S. Cl. 455/436

(57) ABSTRACT

The invention provides a communication continuation system for enabling the communication before handover to be continued after handover when a mobile node is moved from one network to another.

The invention relates to a mobile node and a gateway for use in the communication in which the IP address of the mobile node is changed by handover, in which a connection management module for the mobile node and the gateway stores the connection information before handover for the mobile node, and associates it with the connection information after handover, thereby enabling the communication before handover to be continued after handover.

### BACKGROUND OF THE INVENTION

1. Field of the Invention

The present invention relates to a communication system, a communication method, and a mobile node and a gateway for use with the system, and more particularly to a communication system and a communication method for allowing the communication to be continued when a mobile node is moved from one network to another, and a mobile node and a gateway for use with the system.

2. Description of the Related Art

Conventionally, the Internet access from a mobile unit was an expensive method on the circuit switching basis using a portable telephone or PHS (Personal Handy-phone System). In recent years, in addition, a wireless LAN (Local Area Network) has appeared as inexpensive connecting means on an IP (Internet Protocol) basis without using the circuit switching. A handover between different mobile networks has gained attention.

By the handover, it is meant that when the mobile node is moved from a current link to another link during the communication with a communication distant node using the IP, the IP address of the mobile node is changed.

The MobileIPv4 and MobileIPv6 are provided as means for implementing the handover.

On the other hand, a wireless access system has been disclosed which resolves the overhead in updating the IP address to improve the throughput in the wireless Internet access, and reduces the processing time for changing the IP address with the overhead (refer to patent document 1).

This system performs a proxy operation for an accommodated mobile terminal by providing a TCP relaying function and an IP relaying function for a base station. The mobile terminal gains access to the base station, using a fixed IP address, while the base station operates an IP proxy function to perform the proxy transmission and reception using an IP address accessible from the outside. Simultaneously, with the TCP relaying function, the TCP link for a wireless circuit and a wire circuit is analyzed to make a link control suitable for each circuit.

[Patent Document 1]

Japanese Patent Laid-Open No. 2002-208944 (paragraphs 0015, 0016)

However, because MobileIPv4 involves a great number of introducing devices which consume most of a small number of IPv4 addresses, and MobileIPv6 itself has not spread, MobileIPv4 and MobileIPv6 are not put to practical use. Under these circumstances, another means for implementing the handover rapidly is prospected.

On the other hand, with the technique as disclosed in patent document 1, the base station stands proxy for a hand over processing at the mobile terminal to reduce the processing load of the mobile terminal. Though the IP address of the mobile terminal is invariant, this invention is concerned with the technique in which the IP address of the terminal is changed at the time of handover, and the handover itself is enabled. Accordingly, the technique of the invention is quite different in the configuration, operation and effect from the technique as disclosed in patent document 1.

### SUMMARY OF THE INVENTION

Thus, it is an object of the invention to provide a communication system and a communication method for enabling the communication before handover to be continued after handover, and a mobile node and a gateway for use with the system.

In order to achieve the above object, the present invention provides a communication system for enabling a mobile node residing in a first communication network to communicate via a gateway with a communication distant node, comprising connection information control means for exchanging the connection information before handover and the connection information after handover between the mobile node and the gateway, when the mobile node is moved to a second communication network.

Also, the invention provides a communication method for enabling a mobile node residing in a first communication network to communicate via a gateway with a communication distant node, comprising a connection information control step of exchanging the connection information before handover and the connection information after handover between the mobile node and the gateway, when the mobile node is moved to a second communication network.

Also, the invention provides a mobile node in a communication system for enabling the mobile node residing in a first communication network to communicate via a gateway with a communication distant node, comprising a network interface for mediating the communication with the first communication network, a user interface for mediating the communication with the user, and a control unit for controlling the interfaces, the control unit further comprising a program storing memory, in which the program storing memory stores a connection management module for exchanging the connection information before handover and the connection information after handover between the mobile node and the gateway, when the mobile node is moved to a second communication network.

Also, the invention provides a mobile node communication method for a mobile node in a communication system for enabling the mobile node residing in a first communication network to communicate via a gateway with a communication distant node, comprising a connection information control step of exchanging the connection information before handover and the connection information after handover between the mobile node and the gateway, when the mobile node is moved to a second communication network.

Also, the invention provides a gateway in a communication system for enabling a mobile node residing in a first communication network to communicate via the gateway with a communication distant node, comprising a mobile node network interface for mediating the communication with a third communication network on the side of the mobile node, a communication distant node network interface for mediating the communication with a fourth communication network on the side of the communication distant node, and a control unit for controlling the interfaces, the control unit further comprising a program storing memory, in which the program storing memory stores a connection management module for exchanging the connection information before handover and the connection information after handover between the mobile node and the gateway, when the mobile node is moved to a second communication network.

Also, the invention provides a gateway communication method for a gateway in a communication system for enabling a mobile node residing in a first communication network to communicate via the gateway with a communication distant node, comprising a connection information control step of exchanging the connection information before handover and the connection information after handover between the mobile node and the gateway, when the mobile node is moved to a second communication network.

The invention with the above configuration enables the communication before handover to be continued after handover.

### BRIEF DESCRIPTION OF THE DRAWINGS

FIG. 1 is a block diagram showing a communication system in the best mode according to the present invention;

FIG. 2 is a sequence diagram showing an operation of notifying the connection information at the start time of communication;

FIG. 3 is a sequence diagram showing an operation after handover;

FIG. 4 is a configuration table of one example of a protocol stack;

FIG. 5 is a configuration table of another example of a protocol stack;

FIG. 6 is a block diagram of one example of a mobile node 100;

FIG. 7 is a block diagram of one example of a gateway 101;

FIG. 8 is a block diagram of one example of a connection management module 200;

FIG. 9 is a block diagram of one example of a connection management module 201; and

FIG. 10 is a configuration table of an MITF dialup dormant protocol stack.

### DETAILED DESCRIPTION OF THE PREFERRED EMBODIMENTS

Conventionally, when a mobile node moved from a current link to another link during the communication with a communication distant node using the IP, so that the IP address of the mobile node was changed (handover), the mobile node could not continue the communication before move.

This invention enables the communication before handover to be continued after handover by applying a connection management module with an extended MITF (Mobile Internet Access Forum) dialup dormant protocol (ARIB STD-T78) to the mobile node and a communication apparatus (hereinafter a gateway apparatus) between the mobile nodes.

In the communication using the IP, the communication is performed using the connection information (transmission source IP address, transmission destination IP address, and transmission source port number and transmission destination port number, if the TCP (Transmission Control Protocol) or UDP (User Datagram Protocol) is employed for the transport layer protocol), and if anyone of those pieces of connection information is changed, the communication changes into another communication. Therefore, when the IP address of the mobile node was changed due to handover, the communication could not be continued.

This invention is concerned with the mobile node and the gateway apparatus in the communication when the IP address of the mobile node is changed due to handover, in which a connection management module for the mobile node and the gateway apparatus stores the connection information before handover for the mobile node, and associates it with the connection information after handover, thereby enabling the communication before handover to be continued after handover.

The connection management module uses an extended MITF dialup dormant protocol. The MITF dialup dormant protocol is extended so that the connection information may be set up in an additional information frame for the connection request and reconnection request for the MITF dialup dormant protocol, thereby communicating the connection information between the mobile node and the gateway apparatus.

There are two types of connection management module depending on the configuration of the protocol stack.

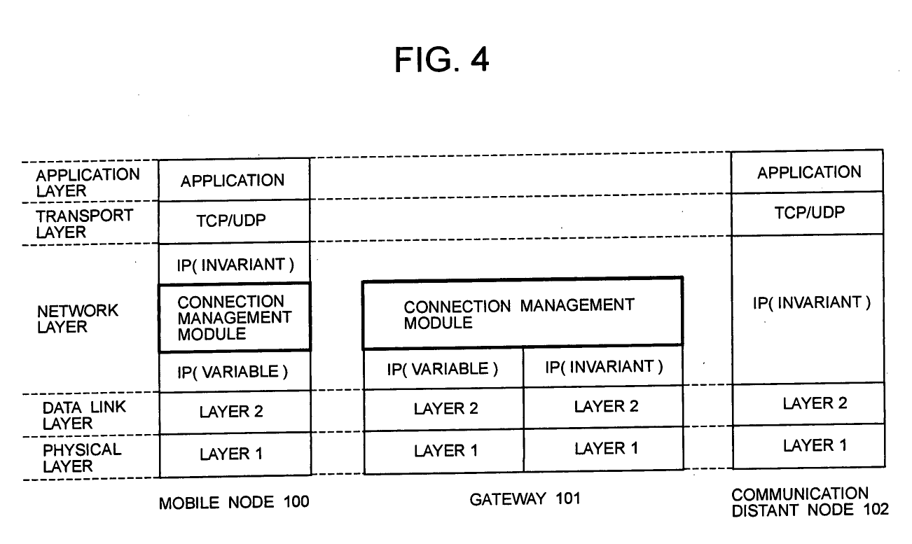

A first type of the connection management module is located on the network layer, taking a protocol stack configuration of FIG. 4. Even when the IP address of the mobile node 100 on a lower layer of the connection management module is changed due to handover, the connection management module has a change of the IP address hidden from the transport layer, thereby enabling the communication before handover to be continued after handover. In this case, the connection information includes the transmission source IP address and the transmission destination IP address.

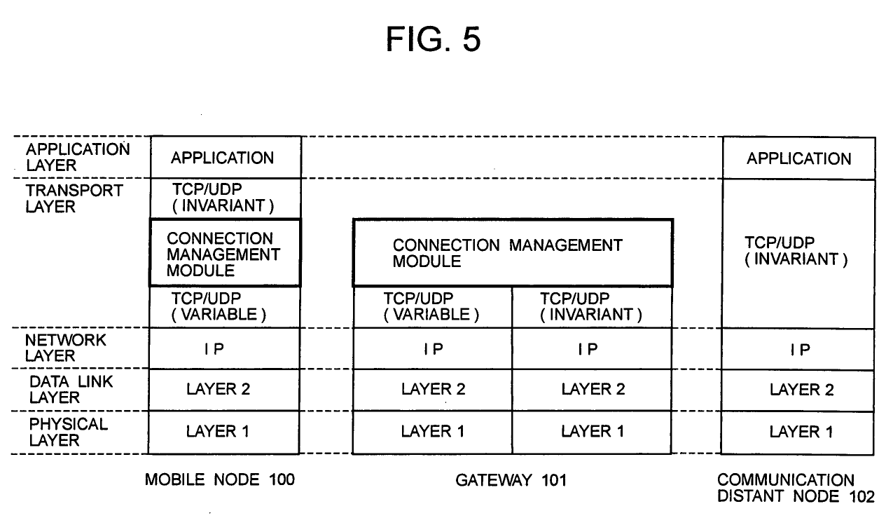

A second type of the connection management module is located on the transport layer, taking a protocol stack configuration of FIG. 5. The connection management module has a change of the transport layer due to handover hidden from the application layer, thereby enabling the communication before handover to be continued after handover. In this case, the connection information includes the transmission source IP address, the transmission destination IP address, the transmission source port number, the transmission destination port number, and the kind of transport layer (TCP or UDP).

The MITF dialup dormant protocol as the existent technique has a protocol stack configuration of FIG. 10, in which a disconnection of the physical layer is hidden from the PPP (Point to Point Protocol) of the upper-level layer.

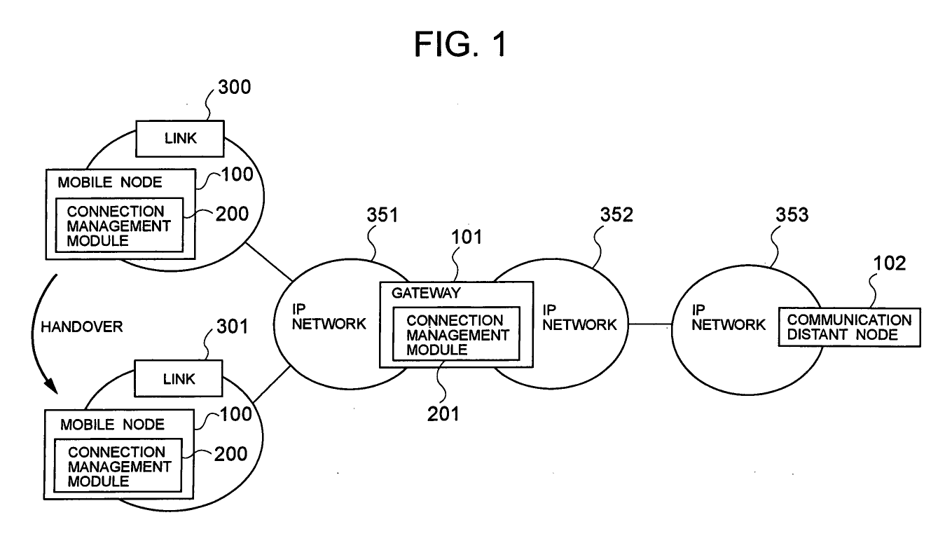

A principle of this invention is shown in FIG. 1. FIG. 1 is a block diagram showing a communication system in the best mode according to the invention. In FIG. 1, the communication system comprises a mobile node 100 residing at a link 300 (first communication network), a gateway 101, a communication distant node 102 residing in an IP network (fifth communication network) 353, an IP network (third communication network) 351 between the link 300 and the gateway 101, and an IP network (fourth communication network) 352 between the gateway 101 and the IP network 353.

Moreover, the mobile node 100 comprises a connection management module 200, and the gateway 101 comprises a connection management module 201.

In FIG. 1, the mobile node 100 is moved from the link 300 to the link 301 (connected to a second communication network: IP network 351).

When the mobile node 100 residing in the link 300 starts to communicate with the communication distant node 102, the connection management module 200 having a connection management function of the mobile node 100 notifies the connection information of this communication to the connection management module 201 having a connection management function of the gateway 101, and then starts to communicate with the communication distant node 102. Also, the connection management modules 200 and 201 store this connection information.

When the mobile node 100 is handed over from the link 300 to the link 301 during the communication with the communication distant node 102, the connection management module 200 of the mobile node 100 notifies the connection information changed by handover to the connection management module 201 of the gateway 101. Also, the connection management modules 200 and 201 store this connection information.

The connection information of packet with which the mobile node 100 communicates with the communication distant node 102 is the connection information before handover. The module 200 of the mobile node 100 rewrites it with the connection information after handover and transmits the rewritten connection information, and the module 201 of the gateway 101, if receiving a packet having the connection information after handover from the mobile node 100, rewrite it with the connection information before handover and transfers the rewritten connection information to the communication distant node 102.

Also, if receiving a packet having the connection information before handover from the communication distant node 102, the module 201 of the gateway 101 rewrites it with the connection information after handover, and transfers the rewritten connection information to mobile node 100. If receiving a packet having the connection information after handover, the module 200 of the mobile node 100 rewrites it with the connection information before handover.

In this way, after handover, the communication can be made using the connection information before handover, whereby the communication before handover can be continued after handover.

### EXAMPLE

One example of the invention will be described below. The configuration of the communication system is the same as shown in FIG. 1. Referring to FIG. 1, the mobile node 100 at the link 300 has the connection management module 200 having the connection management function to communicate with the communication distant node 102. And the mobile node 100 moves to the link 301 during the communication with the communication distant node 102.

The gateway 101 is a data relaying apparatus between the mobile node 100 and the communication distant node 102 and has the connection management module 201 having the connection management function.

The link 300 and the link 301 are a mobile network for the mobile node 100 and have mutually different network addresses.

The connection management modules 200 and 201 have the connection management function. The connection management module 200 notifies the connection information to the connection management module 201. And the packet is transformed based on this connection information.

Explanation of the Operation of Example

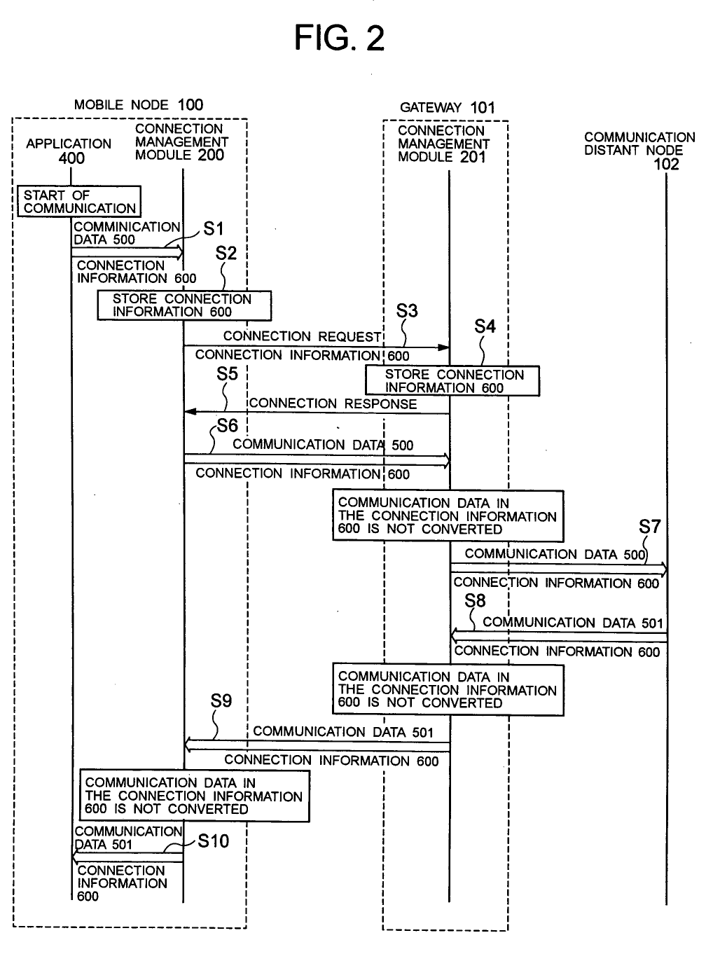

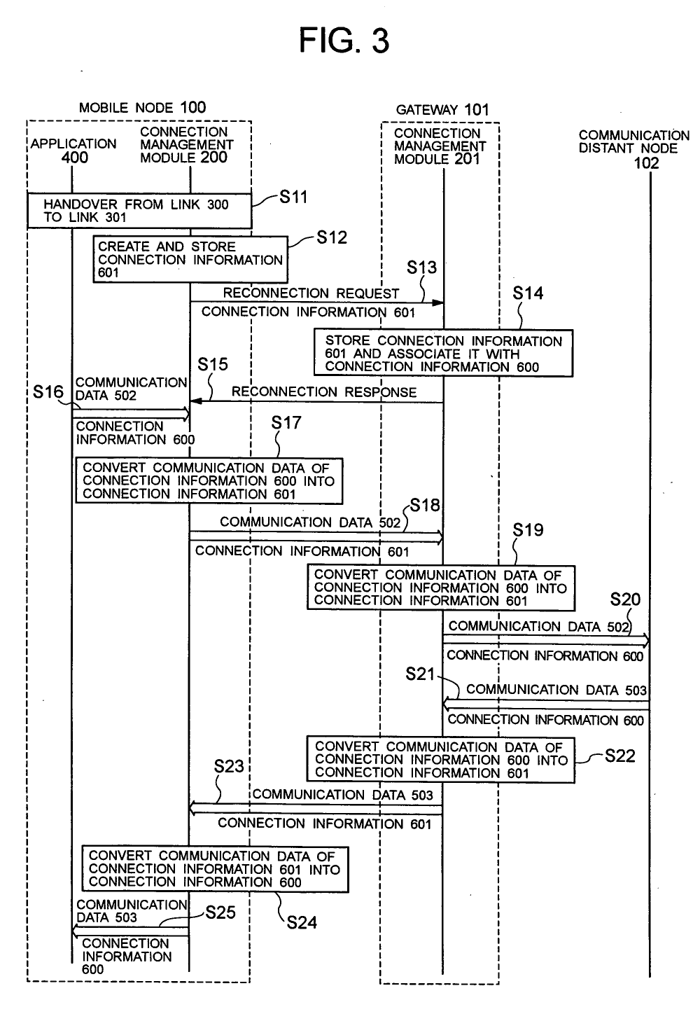

Referring to FIG. 2, first of all, an operation of notifying the connection information at the start time of communication will be described. Then, referring to FIG. 3, an operation after handover will be described below.

FIG. 2 is a sequence where an application 400 for the mobile node 100 at the link 300 starts to communicate with the communication distant node 102.

When the application 400 starts to communicate with the communication distant node 102, the application 400 creates and transmits the communication data 500 including the connection information 600 (S1).

The connection management module 200 for the communication node 100 stores the connection information 600 of the communication data 500 without immediately transmitting the communication data 500 from the application 400 (S2), and transmits the connection information 600 to the gateway 101 upon a connection request (S3).

The connection management module 201 for the gateway 101 receives the connection request from the mobile node 100 (S3), stores the connection information 600 (S4), and transmits a connection response to the mobile node 100 (S5).

The connection management module 200 for the mobile node 100 receives the connection response from the gateway 101 (S5), and transmits the communication data 500 from the application 400 to the communication distant node 102 (S6).

The connection management module 201 for the gateway 101 directly transfers the communication data 500 including the connection information 600 destined from the mobile node 100 to the communication distant node 102 to the communication distant node 102 (S7).

The connection management module 201 for the gateway 101 receives the communication data 501 including the connection information 600 destined from the communication distant node 102 to the mobile node 100 (S8), and directly transfers it to the mobile node 100 (S9).

The mobile node 100 receives the communication data 501 including the connection information 600 from the communication distant node 102 (S9), and directly passes it to the application 400 (S10).

FIG. 3 is a sequence diagram after the mobile node 100 is handed over from the link 300 to the link 301 during the communication of FIG. 2.

The connection management module 200 detects a handover (S11), changes the connection information 600 for a changed part by handover to create and store the connection information 601 (S12), and transmits the connection information to the gateway 101 upon a reconnection request (S13).

The module 201 for the gateway 101 receives the reconnection request from the mobile node 100 (S13), stores the connection information 601 in the reconnection request and associates the connection information 601 with the connection information 600 (S14), and transmits a reconnection response to the mobile node 100 (S15).

The connection management module 200 for the mobile node 100 receives the reconnection response from the gateway 101 (S15), accepts the communication data 502 of the connection information 600 from the application 400 (S16), converts the connection information 600 into the connection information 601 (S17), and transmits the connection information 601 to the gateway 101 (S18).

The connection management module 201 for the gateway 101 receives the communication data 502 of the connection information 601 from the mobile node 100 to the communication distant node 102 (S18), converts the connection information 601 into the connection information 600 (S19), and transfers it to the communication distant node 102 (S20).

The connection management module 201 for the gateway 101 receives the communication data 503 of the connection information 600 from the communication distant node 102 to the mobile node 100 (S21), converts the connection information 600 into the connection information 601 (S22), and transfers it to the mobile node 100 (S23).

The connection management module 200 for the mobile node 100 receives the communication data 503 of the connection information 601 from the communication distant node 102 to the mobile node 100 (S23), converts the connection information 601 into the connection information 600 (S24), and passes it to the application 400 (S25).

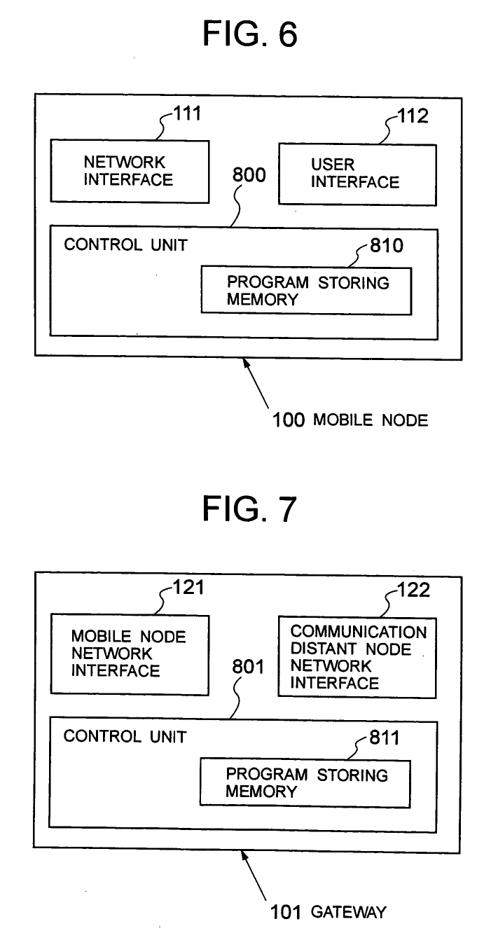

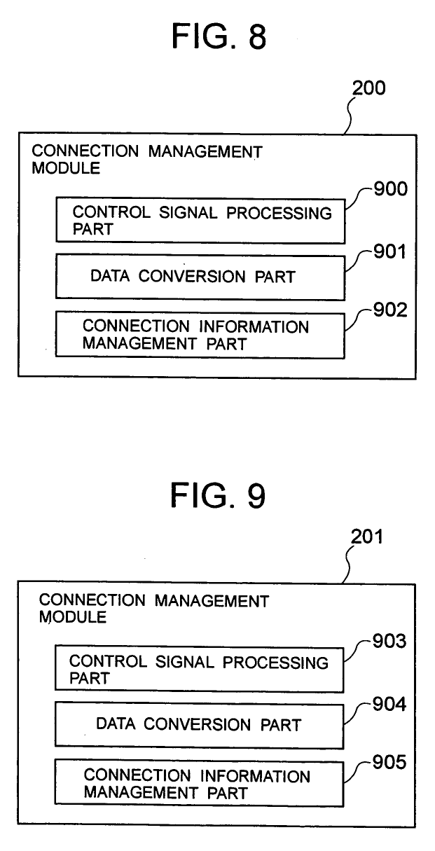

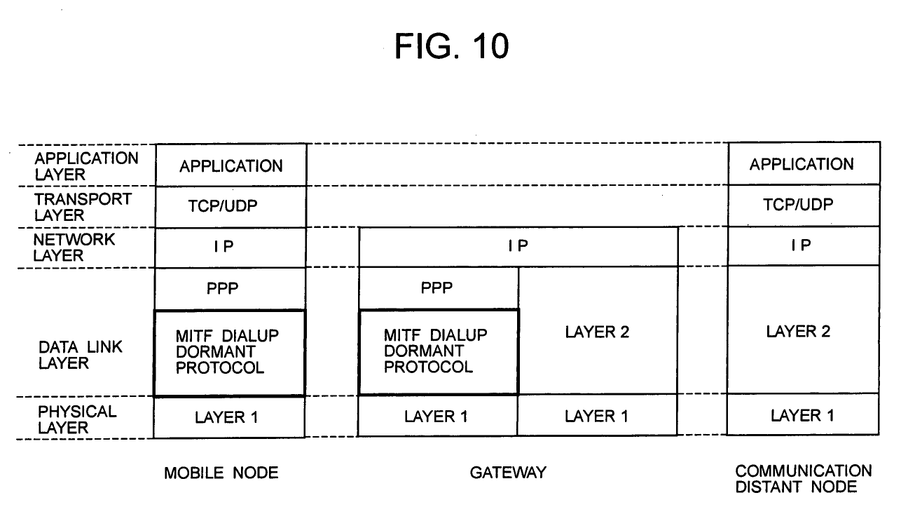

The configuration and operation of the mobile node 100, the gateway 101 and the connection management modules 200, 201 will be described below. FIG. 6 is a block diagram of one example of the mobile node 100, FIG. 7 is a block diagram of one example of the gateway 101, FIG. 8 is a block diagram of one example of the connection management module 200, and FIG. 9 is a block diagram of one example of the connection management module 201.

First of all, the mobile node 100 will be described. Referring to FIG. 6, the mobile node 100 comprises a network interface 111 for mediating the communication with the link 300, a user interface 112 for mediating the communication with the user, and a control unit 800 for controlling the interfaces. And the control unit 800 comprises a program storing memory 810. The connection management module 200 is contained in the program storing memory 810.

The gateway 101 will be next described. Referring to FIG. 7, the gateway 101 comprises a mobile node network interface 121 for mediating the communication with the IP network 351, a communication distant node network interface 122 for mediating the communication with the IP network 352, and a control unit 801 for controlling the interfaces. And the control unit 801 comprises a program storing memory 811. The connection management module 201 is contained in the program storing memory 811.

The connection management module 200 will be next described. Referring to FIG. 8, the connection management module 200 comprises a control signal processing part 900, a data conversion part 901, and a connection information management part 902.

This connection management module 200 is a function in the IP processing part on the network layer for the mobile node 100 in FIG. 4 and in the TCP/IP processing part on the transport layer for the mobile node 100 in FIG. 5.

The control signal processing part 900 has a function of transmitting a control message to the gateway 101 and receiving the control message from the gateway 101. Specifically, a connection request transmitting process (S3) and a connection response receiving process (S5) are made in FIG. 2, and a reconnection request transmitting process (S13) and a reconnection response receiving process (S15) are made in FIG. 3.

The data conversion part 901 has a function of converting the communication data based on the connection information. Specifically, the connection information 600 of the communication data 502 is converted into the connection information 601 (S17) and the connection information 601 of the communication data 503 is converted into the connection information 600 (S24) in FIG. 3.

The connection information management part 902 has a function of storing the connection information. Specifically, the connection information 600 is stored (S2) in FIG. 2, and the connection information 601 is stored (S12) in FIG. 3.

The connection management module 201 will be next described. Referring to FIG. 9, the connection management module 201 comprises a control signal processing part 903, a data conversion part 904, and a connection information management part 905.

This connection management module 201 is a function in the IP processing part on the network layer for the gateway 101 in FIG. 4 and in the TCP/UDP processing part on the transport layer for the gateway 101 in FIG. 5.

The control signal processing part 903 has a function of receiving a control message from the mobile node 100 and transmitting the control message to the mobile node 100. Specifically, a connection request receiving process (S3) and a connection response transmitting process (S5) are made in FIG. 2, and a reconnection request receiving process (S13) and a reconnection response transmitting process (S15) are made in FIG. 3.

The data conversion part 904 has a function of converting the communication data based on the connection information. Specifically, the connection information 600 of the communication data 502 is converted into the connection information 601 (S19) and the connection information 600 of the communication data 503 is converted into the connection information 601 (S22) in FIG. 3.

The connection information management part 905 has a function of storing the connection information. Specifically, the connection information 600 is stored (S4) in FIG. 2, and the connection information 601 is stored (S14) in FIG. 3.

As described above, the invention comprises means for exchanging the connection information before handover and the connection information after handover between the mobile node and the gateway, when the mobile node is moved from the first communication network to the second communication network, and enables the communication before handover to be continued after handover.

Also, the handover is enabled irrespective of the type of mobile network, as far as the IP network is employed. Therefore, the handover is enabled not only between the networks of the same type but also between different networks such as a portable telephone network and a wireless LAN network. Its reason is that the connection management module is located on the upper layer above the IP layer.

What is claimed is:

1. A communication system for enabling a mobile node residing in a first communication network to communicate via a gateway with a communication distant node, comprising connection information control means for exchanging the connection information before handover and the connection information after handover between said mobile node and said gateway, when said mobile node is moved to a second communication network.

2. The communication system according to claim 1, wherein said connection information control means comprises post-handover connection information transmitting means for transmitting the connection information after handover to said gateway at said mobile node, connection information associating means for receiving the connection information and associating it with the connection information before handover at said gateway, and connection information converting means for converting the connection information after handover transmitted from said mobile node into the connection information before handover to transmit the converted connection information to said communication distant node, and converting the connection information before handover transmitted from said communication distant node into the connection information after handover to transmit the converted connection information to said mobile node, based on said association result at said gateway.

3. The communication system according to claim 1, wherein each of said mobile node and said gateway comprises a connection management module, in which said connection information control means is composed of said two connection management modules.

4. The communication system according to claim 3, wherein said connection management module is located on the network layer, in which said connection information includes a transmission source IP address and a transmission destination IP address.

5. The communication system according to claim 3, wherein said connection management module is located on the transport layer, in which said connection information includes a transmission source IP address, a transmission destination IP address, a transmission source port number, a transmission destination port number and a kind of transport layer.

6. A communication method for enabling a mobile node residing in a first communication network to communicate via a gateway with a communication distant node, comprising a connection information control step of exchanging the connection information before handover and the connection information after handover between said mobile node and said gateway, when said mobile node is moved to a second communication network.

7. The communication method according to claim 6, wherein said connection information control step comprises a post-handover connection information transmitting step of transmitting the connection information after handover to said gateway at said mobile node, a connection information associating step of receiving the connection information and associating it with the connection information before handover at said gateway, and a connection information converting step of converting the connection information after handover transmitted from said mobile node into the connection information before handover to transmit the converted connection information to said communication distant node, and converting the connection information before handover transmitted from said communication distant node into the connection information after handover to transmit the converted connection information to said mobile node, based on said association result at said gateway.

8. The communication method according to claim 6, wherein each of said mobile node and said gateway comprises a connection management module, in which said connection information control step is performed by said two connection management modules.

9. The communication method according to claim 8, wherein said connection management module is located on the network layer, in which said connection information includes a transmission source IP address and a transmission destination IP address.

10. The communication method according to claim 8, wherein said connection management module is located on the transport layer, in which said connection information includes a transmission source IP address, a transmission destination IP address, a transmission source port number, a transmission destination port number and a kind of transport layer.

11. A mobile node in a communication system for enabling said mobile node residing in a first communication network to communicate via a gateway with a communication distant node, comprising a network interface for mediating the communication with said first communication network, a user interface for mediating the communication with the user, and a control unit for controlling said interfaces, said control unit further comprising a program storing memory, in which said program storing memory stores a connection management module for exchanging the connection information before handover and the connection information after handover between said mobile node and said gateway, when said mobile node is moved to a second communication network.

12. The mobile node according to claim 11, wherein said connection management module comprises a control signal processing part for transmitting a control message to said gateway and receiving the control message from said gateway, a data conversion part for converting the connection information, and a connection information management part for storing the connection information.

13. The mobile node according to claim 11, wherein said connection management module is located on the network layer, in which said connection information includes a transmission source IP address and a transmission destination IP address.

14. The mobile node according to claim 11, wherein said connection management module is located on the transport layer, in which said connection information includes a transmission source IP address, a transmission destination IP address, a transmission source port number, a transmission destination port number and a kind of transport layer.

15. A mobile node communication method for a mobile node in a communication system for enabling said mobile node residing in a first communication network to communicate via a gateway with a communication distant node, comprising a connection information control step of exchanging the connection information before handover and the connection information after handover between said mobile node and said gateway, when said mobile node is moved to a second communication network.

16. The mobile node communication method according to claim 15, wherein said connection information control step comprises a control signal processing step of transmitting a control message to said gateway and receiving the control message from said gateway, a data conversion step of converting the connection information, and a connection information management step of storing the connection information.

17. The mobile node communication method according to claim 15, wherein said connection information control step is located on the network layer, in which said connection information includes a transmission source IP address and a transmission destination IP address.

18. The mobile node communication method according to claim 15, wherein said connection information control step is located on the transport layer, in which said connection information includes a transmission source IP address, a transmission destination IP address, a transmission source port number, a transmission destination port number and a kind of transport layer.

19. A gateway in a communication system for enabling a mobile node residing in a first communication network to communicate via said gateway with a communication distant node, comprising a mobile node network interface for mediating the communication with a third communication network on the side of said mobile node, a communication distant node network interface for mediating the communication with a fourth communication network on the side of said communication distant node, and a control unit for controlling said interfaces, said control unit further comprising a program storing memory, in which said program storing memory stores a connection management module for exchanging the connection information before handover and the connection information after handover between said mobile node and said gateway, when said mobile node is moved to a second communication network.

20. The gateway according to claim 19, wherein said connection management module comprises a control signal processing part for receiving a control message from said mobile node and transmitting the control message to said mobile node, a data conversion part for converting the connection information, and a connection information management part for storing the connection information.

21. The gateway according to claim 19, wherein said connection management module is located on the network layer, in which said connection information includes a transmission source IP address and a transmission destination IP address.

22. The gateway according to claim 19, wherein said connection management module is located on the transport layer, in which said connection information includes a transmission source IP address, a transmission destination IP address, a transmission source port number, a transmission destination port number and a kind of transport layer.

23. A gateway communication method for a gateway in a communication system for enabling a mobile node residing in a first communication network to communicate via said gateway with a communication distant node, comprising a connection information control step of exchanging the connection information before handover and the connection information after handover between said mobile node and said gateway, when said mobile node is moved to a second communication network.

24. The gateway communication method according to claim 23, wherein said connection information control step comprises a control signal processing step of receiving a control message from said mobile node and transmitting the control message to said mobile node, a data conversion step of converting the connection information, and a connection information management step of storing the connection information.

25. The gateway communication method according to claim 23, wherein said connection information control step is located on the network layer, in which said connection information includes a transmission source IP address and a transmission destination IP address.

26. The gateway communication method according to claim 23, wherein said connection information control step is located on the transport layer, in which said connection information includes a transmission source IP address, a transmission destination IP address, a transmission source port number, a transmission destination port number and a kind of transport layer.
